(19) United States
(12) Patent Application Publication
(10) Pub. No.: US 2011/0099083 A1
(43) Pub. Date: Apr. 28, 2011

(54) Online video marketplace

(76) Inventor: Dmitry Karpinsky, Scottsdale, AZ (US)

(21) Appl. No.: 12/589,558

(22) Filed: Oct. 26, 2009

(51) Int. Cl. G06Q 30/00; G06Q 50/00; H04N 7/173

(52) U.S. Cl. 705/26.25; 709/218; 725/104

(57) ABSTRACT

A system and method for publishing video, processing, storing and purchasing the video over the Internet. The system includes a seller user interface where a seller can register and upload the video over the Internet, and still retain the copyright ownership of the video. Once uploaded video is processed and encoded with copyright notices, it is then available for searches. The system stores the video and user profiles in the database. The system includes a buyer user interface where a registered buyer can search and purchase video content over the Internet. The video can be purchased by many buyers for usage or it can be purchased for exclusive rights by one buyer, after which time the video is deleted from the system and the buyer gets the video copyright ownership. Once a transaction is made, the buyer pays for the video to the seller and listing fees are deducted in the transaction.

### CROSS REFERENCE TO RELATED APPLICATIONS

| Pat. # | Title | Date Issued |
|---|---|---|
| 5,550,982 | Video application server | Sep. 17, 1996 |
| 5,557,317 | Video-on-demand system with program relocation center | Sep. 17, 1996 |
| 5,644,714 | Video collection and distribution system with interested item notification | Jul. 1, 1997 |
| | and download on demand | |
| 5,956,716 | System and method for delivery of video data over a computer network | Sep. 21, 1999 |
| 6,055,314 | System and method for secure purchase and delivery of video content | Apr. 25, 2000 |
| | programs | |
| 6,181,867 | Video storage and retrieval system | Jan. 30, 2001 |
| 6,286,139 | Internet-based video ordering and system | Sep. 4, 2001 |
| 6,507,727 | Purchase and delivery of digital content using multiple devices and date | Jan. 14, 2003 |
| 6,564,380 | System and method for sending live video on the Internet | May 13, 2003 |
| 6,655,580 | System and method for renting or purchasing digital media | Dec. 2, 2003 |
| 6,801,576 | System for accessing, distributing and maintaining video content over | Oct. 5, 2004 |
| | public and private Internet protocol networks | |

### FIELD OF THE INVENTION

This invention relates to publishing videos and ability to search and purchase the videos over the Internet for exclusive or non-exclusive rights usage.

### BACKGROUND OF THE INVENTION

The present invention relates to a system and method to allow users to submit and purchase videos using Internet communication.

The increased proliferation of digital media and storage has enabled individuals to record and store videos using their digital cameras, video cameras, web cams, cell phones and personal digital assistants in digital format. The videos may include newsworthy stories, videos of famous actors, personal videos and the like. This invention enables these users to publish their video content online and get paid for their content. The buyers can browse the videos, search for video type, create search agents and make a decision to purchase the video for exclusive or non-exclusive rights usage.

While there are systems known in the prior art for distributing videos, video-on-demand (VOD), viewer's set-top-box (STB), digital media transactions, there is no prior art for similar embodiment that allow the seller to submit the video onto the marketplace while retaining copyright and ownership, for the video to be encoded with copyrighted image watermark, for buyer to browse for videos, search for videos, create search agents and purchase videos with either exclusive or non-exclusive rights usage. If the video is purchased under exclusive rights, it would no longer be available on the system for others to view it.

Some referenced patents are discussed, none of which allow the user to submit a video and retain copyright ownership, for the video to be encoded after the submission, the buyer to purchase the video for exclusive rights usage, or the seller to get paid for the video. Pat. No. 5,550,982 involves video application server that transmits videos over the local area network (IAN) but makes no provision for video transactions over the Internet. Pat. Nos. 5,557,317 and 5,557,317 provide for VOD type transactions where digital media is broadcast to subscribers, but does not provide for video exclusivity. Pat. Nos. 5,956,716 and 6,564,380 allow for video to be delivered over a network, but make no provision for encoding the video or transaction processing. Pat. No. 6,055,314 allows for secure purchase and delivery of video, but this system uses secure keys and video encryption. Patent 6,181,867 allows for video clips to be stored and retrieved but makes no provision for full length video, transaction neither processing nor encoding video. Pat. No. 6,286,139 allows Internet based video ordering system but is more in line with video on demand ordering and makes no provision to account management, escrow accounts, video encoding or exclusive rights purchases. Pat. No. 6,507,727 makes provisions for content delivery but does not enable the video content be purchased for exclusive rights or for video to be encoded during viewing. Pat. No. 6,655,580 allows video content to be rented but not purchased. Pat. No. 6,801,576 allows video content transactions over the Internet but does not provide for video encoding or exclusive right privileges of the video.

The objective of this invention is to create a marketplace to allow sellers to make their videos available for purchase for the buyers, which may go to private collections or allow for videos to be advertised in news stories.

### SUMMARY OF THE INVENTION

The present invention provides a system for distributing and purchasing video content over the Internet.

In a preferred embodiment of the invention, aspects of the system include web-based user interface that allow a seller to register and create user account. The sellers then can upload one or more videos online from cell phones, web cams, computers or other wireless devices connected to the Internet, and enter details about the video through online forms. The seller next decides to publish the video for exclusive rights sale or multiple uses and determines the price for each type of sale. Typically the video will be available only for exclusive rights or non-exclusive rights, but not both. If the video is first purchased for non-exclusive rights, it would not be available for exclusive rights to someone else as more than one party would have the video. The seller also acknowledges that he is the true owner of the video and the video was taken without any laws being broken or copyright violations. The video is then loaded onto the system database through the Internet.

The video gets processed and encoded with a “copyright” watermark stamp that is visible on the video when anyone plays the video. The video is then available to be viewed and searched. The seller can manage and maintain his account and remove the video at any time, or upload more videos.

Buyers can register and create user accounts through a web-based user interface. The buyers can search the system for videos which are presented to them in copyright format. If the prospective buyer searches the system but no video is found that matches the search criteria, the buyers can establish search criteria, or an “agent”. Once someone publishes a video within the specifications of the agent, a notice is sent to the buyer. The buyer can then view the video. Once the buyer decides to purchase the video, the video is delivered to the buyer or available for download without the copyright stamp and the buyer can use the video. If the buyer purchases the video for exclusive rights, the video is removed from search list.

After the purchase, the transaction processing occurs where the monetary funds are exchanged and the buyer pays for the video. The funds get transferred to the seller and portion may get debited to the intermediary as a listing fee.

### DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain in the principles of the invention.

FIG. 1 is a context diagram of all major aspects of the invention;

FIG. 2 is a diagram view of the invention.

### DETAILED DESCRIPTION OF THE INVENTION

It is understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not considered limiting unless the claims expressly state otherwise. Accordingly, various modifications may be made without departing from the spirit of scope of the general inventive concept as defined by the appended claims and their equivalents.

An embodiment of the present invention will be described below with reference to the accompanying drawings.

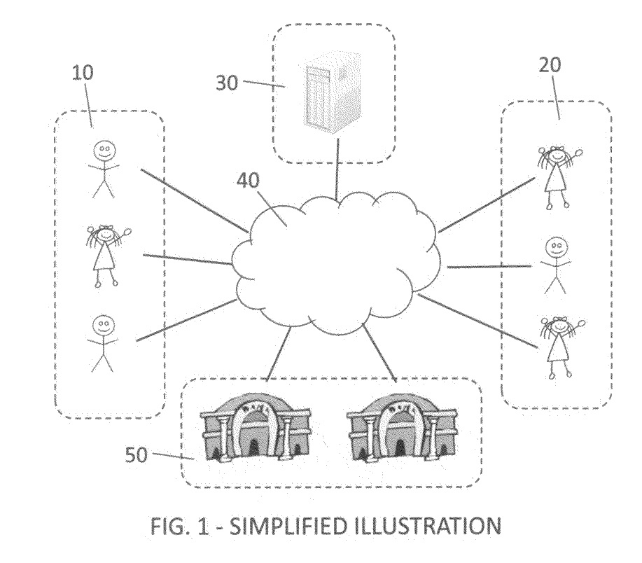

Referring now in detail to the drawings and in particular to FIG. 1 thereof, the numeral 10 denotes the Seller. There may be multiple Sellers. Sellers generally have one or more video that they want to publish and get paid for. Sellers can be individuals, companies, videographers, paparazzi and the like. Numeral 20 represents Buyers. There may be multiple Buyers and they are interested in purchasing one or more video. These can be individuals, investors, companies, news networks, newspapers and so forth. The system that stores the videos is represented by numeral 30. That consists of servers, databases, workflow, rules engines, transaction processing and the complete information system to run the submission, processing, storage and retrieval of videos. The videos can be digital media, videos, video clips, trailers, web cam clips, movies or animation. Financial institutions are represented by numeral 50. These are entities that hold Seller and Buyer bank accounts or credit cards. The Sellers, Buyers, System and Banks and the major components of this invention and interact and perform transaction processing through Internet 40.

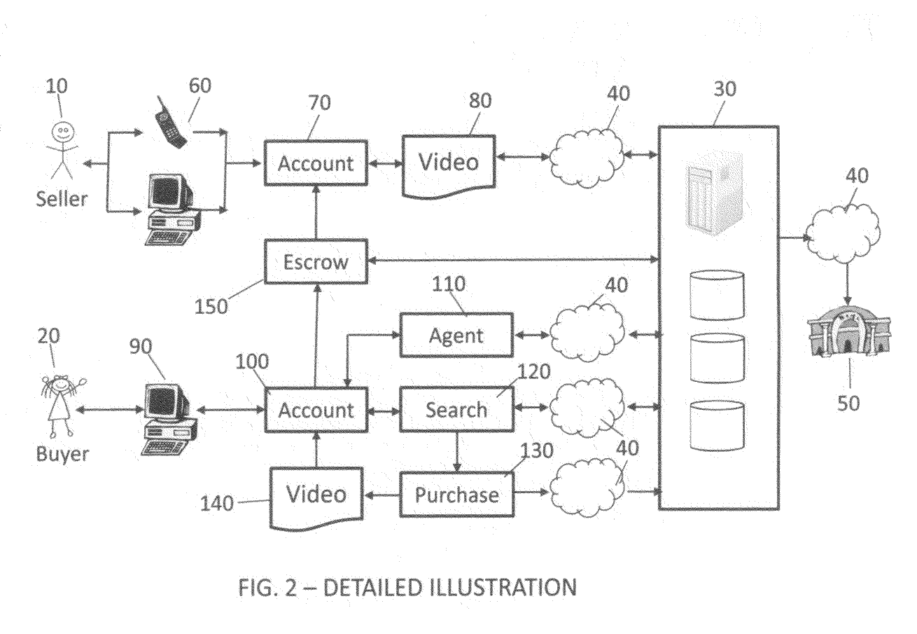

FIG. 2 is a detailed illustration of the system. The Seller 10 can access his or her account and submit the videos through number of channels 60 including personal digital assistants, cell phones, personal digital assistants, computers; any channel as long as it has a web browser, connected to the Internet through wired or wireless connection and has access to the video file. The Seller must first register for an account 70. Here the Seller provides personal information such as name, address, phone, email addresses. The Seller also provides bank or credit card information in order to get paid for the videos that will be submitted. If the Seller does not provide bank or credit card information, the Seller can get paid by a Bank check and sent to address in the account. That information is stored securely on the system 30. After the User registers, the video can be submitted. The video can be of any video format and prior to submission 80; the Seller must enter video information or characteristics. The Seller needs to enter such information as the name of the video, date it was taken, type of equipment used and format of the video, brief description of what is in the video and detailed description. This description will be converted into meta-tags by the system and be used for searches. The information will help Buyers search for the video. Thus the more detailed the information is provided, the greater the chance of the Buyer finding the video. For instance, the Seller can enter that the video was of a rollover accident on highway 10 resulting in 5 injuries. Or the Seller can enter that the video is a candid footage of a known celebrity. Or the video is that of a riot or burglary. Or the video is about natural habitat of the lions in Africa.

Next, the Seller must enter information whether this video is to be sold for anyone to use, or only for exclusive rights privilege, and price for each. If it is sold for anyone to use, then any number of Buyers can purchase the video at a set price and use it at their discretion. This video would be available indefinitely for searches and viewing, or until the Seller removes the video from the database. In this scenario, multiple news networks can buy the video and telecast it. Or any number of college students can buy the video and use it for their college project. The Seller would maintain copyright on the video.

However, if the video is designated for exclusive rights usage, the price would be higher and there would only be one Buyer. That Buyer could in turn sell the video on the open market or use it exclusively as the Buyer wants. The Buyer would own the copyright to the video purchased. Once the Buyer purchases the video, the system would make the video unavailable for searches or viewing online.

The Seller then sets the price for the video, or keeps the price open and lets the Buyer notify the Seller what price the Buyer is willing to pay.

The Seller then acknowledges that the video does not violate any laws, and that the Seller has copyright rights to the video. Once those parameters are set by the Seller, the video is then uploaded onto the system 30 through the Internet.

Once the video is uploaded, it is then indexed and processed by the system. After processing is performed, it is stored in the system databases 30. During the processing, the video is encoded with a watermark overlay that says “Copyrighted Content, Do not distribute” or similar copyright language. When anyone searches and views the video, this image would continuously appear on the video until the video is bought. The video can also be converted into another video file to create trailers or smaller files for faster downloads or viewing/streaming through the Internet. The system contains application servers, video servers, database servers, rules engines. The application servers maintain look and feel of the web content that is presented to the Buyer and the Seller. It also pulls and pushed content to the user. The video servers run the videos and stream the videos to the potential buyers. The databases securely hold the videos and account information of the users of the system. The rules engines perform logic that is necessary to know when transaction processing is initiated, when exclusive rights video is bought and can no longer be broadcast, where to send search agent results, and so forth. The system also contains the physical hardware of the computers, software & the network. The actual configuration of the system can vary greatly and be configurable in almost infinite possibilities, although the major components are discussed here.

Next the Buyer 20, who is interested in purchasing a video logs on through a computer 90. The Buyer can browse or search the videos without having an account, but in order to purchase the videos, the Buyer needs to have an account established 100. The Seller can also be the Buyer and can use the same account. A Seller can submit videos and can also buy videos. Here the Buyer enters personal information and financial information. Financial information is not needed until the Buyer decides to purchase the video. At that time the financial information will be required to complete the transaction. This is where the Buyer specifies what bank account or credit card to use for monetary transactions.

The Buyer has several search options. The Buyer can conduct a quick search 120 or detailed search 120 to look for a video. In quick search the Buyer can enter a simple text string of key words. These will be used to search the video against the meta-tags associated with the video. The Buyer also has an option to do a detailed search by date, range, title, description, video format, price, exclusive or non exclusive video, Seller user name, length and so forth. For example, the Buyer can specify to search for an actor videotaped between January 1 and February 15 in a given year, or for stabbing in the courthouse in certain city, or for videos priced between $500 or $1,000, and so forth. The searches run through the Internet 40 and pull the information from the system 30, which are then displayed to the Buyer.

The Buyer also has an option to create a search agent 110 or multiple search agents. If the Buyer is interested in certain videos, the Buyer can enter this information in the search agent, save and run it. The search agent can be indefinite or with an expiration date. This is helpful if the Buyer has certain deadlines where he may need a video by. For example, the Buyer searches for video consisting of illegal immigration raids in Phoenix, but nothing comes up. The Buyer can then create an agent and list key words such as “illegal immigration raids” and “Phoenix”, and then run the agent. The agent will run on the system in the background and when a new video is uploaded with this information at anytime, the video clip or the link to the video will be emailed to the Buyer. At that time the Buyer can look at the video and determine whether he or she wants to purchase it. A blog can be established as well, where the Buyer posts comments as to what videos he or she is looking for and perhaps what he is willing to pay for them.

The Buyer can also browse through the videos based on various filters and sorting criteria such as date submitted, length of video, popularity of video, file format, geography of video taken, and so forth. Comprehensive forms can be developed to capture this material from the Seller so that the videos can be searched on and produce better results. The tags can also include type of a video—i.e. crime, accident, war, animals, celebrities, politicians, interviews, and so forth.

When the Buyer gets results of the videos search, the list can be filtered or sorted in number of ways. The Buyer clicks on the specific video and can see the video played with copyright overlay watermark. The video information is also visible as what the Seller entered such as date taken, what the video is about, etc. The Seller information remains private. If the Buyer has specific information on the video, the Buyer can submit the question through online form which is sent to the Seller or to the System. The Seller or the System can respond to the Buyer through online system forms.

If the Buyer decides to purchase the video, and the price is set by the Seller, then the Buyer clicks a link to purchase the system and screen comes up asking for the financial information if the Buyer does not have that filled out. It also specifies how the video is to be sold, unlimited use or exclusive rights use. The Buyer only has those options available to him.

If there is no price set for the video, the Buyer has an ability to send a request through online form to the Seller stating the price the Buyer is willing to pay for the video. The Seller can then accept or reject the offer. If the Seller rejects the offer, the Buyer is notified at which time the Buyer can walk away or the Buyer can increase the monetary offer. If the Buyer accepts the offer, the transaction is initiated and the video is made available for the Buyer to download.

Once the Buyer performs monetary transaction and submits the purchase request, the video is made available on Buyer's account page and will be downloadable without the copyrighted watermark overlay. The funds will be deducted from the Buyer's financial account and placed into escrow account for certain duration to ensure there are no copyright or other issues with the video. If there are no complains within a stated timeframe the funds are then partially dispersed to the system 30 as a listing fee and to the Seller 10 for the video. The funds are processes from the system 30 to the system's bank 50.

The above description is considered that of the preferred embodiments only. Modification of the invention will occur to those skilled in the art and to those who make and use the invention. Therefore, it is understood that the embodiments shown in the drawings and described above are merely for illustrative purposes and are not intended to limit the scope of the invention, which is defined by the following claims. Graphical user interface (GUI) creativity would dictate how the screens are laid out.

The embodiments of the invention in which an exclusive property or privilege is claimed are defined as follows:

1. A System and Method for Online Video Marketplace comprising:
a. sellers that publish videos online;
b. system that processes the video and encodes it with a copyright overlay watermark;
c. system that stores the video and renders it searchable;
d. buyers who can search and purchase the videos;
e. transaction processing;

2. A System and Method for Online Video Marketplace as claimed in claim 1, wherein said invention provides means for Sellers to submit videos through a number of channels such as personal digital assistants, cell phones, personal digital assistants, video game consoles, computers; any channel as long as it has a web browser, connected to the Internet through wired or wireless connection and has access to the video file, and for the Seller to remain a copyright ownership of the video file until it is purchased;

3. A System and Method for Online Video Marketplace as claimed in claim 2, wherein said invention provides means for Sellers to create accounts, maintain accounts, document video information and maintain, upload or delete videos from their phones, computers and similar electronic devices connected wirelessly or wired to the Internet;

4. A System and Method for Online Video Marketplace as claimed in claim 3, wherein said invention provides means for Sellers to establish a price for videos or leave price blank and have the Buyers bid for the video;

5. A System and Method for Online Video Marketplace as claimed in claim 4, wherein said invention provides means for Sellers to receive a bid from the Buyer for the price the Buyer is willing to pay for the video, for the Sellers to accept or reject the offer and for the Buyer to resubmit the offer;

6. A System and Method for Online Video Marketplace as claimed in claim 5, wherein said invention provides means for Sellers to determine whether they want to list the video for exclusive or non-exclusive rights usage;

7. A System and Method for Online Video Marketplace as claimed in claim 6, wherein said invention provides means for the video to be encoded with a copyright language watermark that will be overlaid on top of the video during searches;

8. A System and Method for Online Video Marketplace as claimed in claim 7, wherein said invention provides means to store the video and information and meta tags about the video on the system, allow the videos to be searched, and remove videos if the Seller deletes the video;

9. A System and Method for Online Video Marketplace as claimed in claim 8, wherein said invention provides means to store the Seller information, Buyer information, transaction information and financial information;

10. A System and Method for Online Video Marketplace as claimed in claim 9, wherein said invention provides means to process the raw video file that comes in and convert it into another video file for faster download, streaming and access, including creating trailers or video clips;

11. A System and Method for Online Video Marketplace as claimed in claim 10, wherein said invention provides means for Buyers to browse through the videos by running filters and sort criteria;

12. A System and Method for Online Video Marketplace as claimed in claim 11, wherein said invention provides means for Buyers to search the videos;

13. A System and Method for Online Video Marketplace as claimed in claim 12, wherein said invention provides means for Buyers to create search agents that can notify the Buyer if a video is uploaded with Buyer's search criteria;

14. A System and Method for Online Video Marketplace as claimed in claim 13, wherein said invention provides means for Buyers to view information details of the video and to view a clip or full length video;

15. A System and Method for Online Video Marketplace as claimed in claim 14, wherein said invention provides means for Buyers to send questions about the video to the Seller or to the System for more information;

16. A System and Method for Online Video Marketplace as claimed in claim 15, wherein said invention provides means for Buyers to post blogs on the system to indicate what type of videos they are interested in buying and what they are willing to pay for them;

17. A System and Method for Online Video Marketplace as claimed in claim 16, wherein said invention provides means for Buyers to perform transactions and purchase the video, and to utilize escrow account to disburse the funds partially for the listing fee and partially to the Seller;

18. A System and Method for Online Video Marketplace as claimed in claim 17, wherein said invention provides means for the system to make video unavailable in the search if the video is tagged for exclusive right and the video is purchased;

19. A System and Method for Online Video Marketplace as claimed in claim 18, wherein said invention provides means for a Buyer to pay a fee to the Seller for the video that is purchased;

20. A System and Method for Online Video Marketplace as claimed in claim 19, wherein said invention provides means for a Buyer to pay a listing fee to the System for the video that is purchased.
